(19) United States
(12) Patent Application Publication
(10) Pub. No.: US 2002/0120843 A1
(43) Pub. Date: Aug. 29, 2002

(54) Method and system for preventing reset of a cryptographic subsystem when entering or recovering from a powered-off sleep state

(76) Inventors: Steven Dale Goodman, Raleigh, NC (US); Randall Scott Springfield, Chapel Hill, NC (US); James Peter Ward, Raleigh, NC (US)

Correspondence Address: IBM Corporation, Personal and Printing Systems Group, Dept. 9CCA/Bldg. 002-2, P.O. Box 12195, Research Triangle Park, NC, 27709, US

(21) Appl. No.: 09/790,012

(22) Filed: Feb. 21, 2001

(51) Int. Cl. G06F 9/00

(52) U.S. Cl. 713/164; 713/2; 713/200

(57) ABSTRACT

A method and system for preventing an unauthorized reset of a subsystem in a processing system is disclosed. A first embodiment of a method and system in accordance with the present invention includes receiving notification that the processing system is entering a powered off sleep state, setting a first signal to block a subsystem reset, and locking the first signal to protect the subsystem from intrusion while in and recovering from the powered off sleep state. In another embodiment, a system and method in accordance with the present invention prevents a subsystem reset following a powered off sleep state by including the steps of setting a block signal when the powered off sleep state is being entered, setting a lock signal to lock the block signal, asserting a system reset which releases the lock signal when the system begins recovering from the powered off sleep state, and clearing the block signal so that a device driver regains control of the subsystem reset.

### FIELD OF THE INVENTION

The present invention relates generally to the field of computer security and particularly to a method and system for preventing a cryptographic subsystem reset when the computer system is entering or recovering from a powered-off sleep state.

### BACKGROUND OF THE INVENTION

With the advent of personal computer system use in every day personal and business affairs, the issue of computer security has become critical. To protect the information contained in the personal computer system, which in many cases may be highly sensitive and confidential, cryptographic subsystems have been developed.

Cryptographic subsystems (hereinafter referred to as “subsystems”) in modem personal computer systems (hereinafter “systems”) typically require a POST (Power On Self Test) code to initialize and lock the subsystem to prevent an unauthorized user from tampering with, or gaining access to, confidential information in the system. If the subsystem is implemented as an add-on feature with a POST code that is executed from an optional ROM, the subsystem POST code will not be executed when the system recovers from certain powered down sleep states, such as an S3 sleep state. A system reset generated by the computer system when it is recovering from this sleep state will also reset the subsystem. This subsystem reset unlocks the cryptographic subsystem, making it vulnerable to intrusive attacks. For example, in this unlocked state, an intruder could gain access to confidential information or could change access settings resulting in a denial of services.

The usual solution for preventing this security breach is to block the reset to the subsystem via an I/O bit when the system POST code determines that a sleep state is being entered. This function is usually accomplished by a Basic Input and Output System (“BIOS”).

In the case of an add-on subsystem, however, the subsystem's POST code is not notified when a sleep state is being entered. Thus, the subsystem's POST code will not set a blocking bit to prevent a subsystem reset. Under these circumstances, the subsystem's device driver must be responsible for blocking the subsystem reset and verifying that the block has not been removed or changed.

Simply setting a blocking bit, however, no longer provides adequate protection against a subsystem reset. For instance, the subsystem's device driver may set a blocking bit to prevent a subsystem reset, but beyond that, the device driver cannot prevent a rogue application or driver, executed thereafter, from releasing the block. For example, because device drivers are notified in a certain sequence prior to entering the sleep state, an intruder could load a device driver into the system in a manner that causes it to be notified after the reset is blocked. The new driver could then release the block set by the subsystem's driver. By releasing the block, the subsystem reset can occur. This subsequent reset of the subsystem would unlock the subsystem and leave it exposed for attack while the subsystem's driver attempts to relock the subsystem.

Accordingly, what is needed is a system and method for preventing a cryptographic subsystem reset when the system is recovering from a powered-off sleep state. The method and system should be simple, cost effective and capable of being easily adapted to current technology. The present invention addresses such a need.

### SUMMARY OF THE INVENTION

A method and system for preventing an unauthorized reset of a subsystem in a processing system is disclosed. A first embodiment of a method and system in accordance with the present invention includes receiving notification that the processing system is entering a powered off sleep state, setting a first signal to block a subsystem reset, and locking the first signal to protect the subsystem from intrusion while entering and recovering from the powered off sleep state. In another embodiment, a system and method in accordance with the present invention prevents a subsystem reset following a powered off sleep state by including the steps of setting a block signal when the powered off sleep state is being entered, setting a lock signal to lock the block signal, asserting a system reset which releases the lock signal when the system begins recovering from the powered off sleep state, and clearing the block signal so the subsystem will be reset from power on.

### BRIEF DESCRIPTION OF THE DRAWINGS

FIG. 1 is a block circuit diagram illustrating a preferred embodiment of system in accordance with the present invention.

FIG. 2 is a flowchart illustrating the powered-off sleep state process in accordance with the present invention.

FIG. 3 is a flowchart illustrating the recovery process in accordance with the present invention.

### DETAILED DESCRIPTION

The present invention provides a method and system for preventing a cryptographic subsystem reset when the computer system is recovering from a powered-off sleep state. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The method and system of the present invention utilizes a latch that prevents the subsystem reset block from being unblocked once it has been set by the subsystem device driver, hereinafter referred to as a “sticky” latch. When the subsystem device driver receives notification that a powered-off sleep state is being entered, it sets the block to the subsystem reset, and then sets the “sticky” latch such that the block setting cannot be altered during entry to the sleep state. Upon exit of the sleep state, the system reset is configured to unlock the “sticky” latch, but not the subsystem reset block, thereby allowing the device driver or BIOS to regain control of the subsystem reset. Because the reset to the subsystem is blocked when the system reset occurs, the subsystem remains locked, thus preventing any attack that could occur prior to the subsystem device driver regaining control.

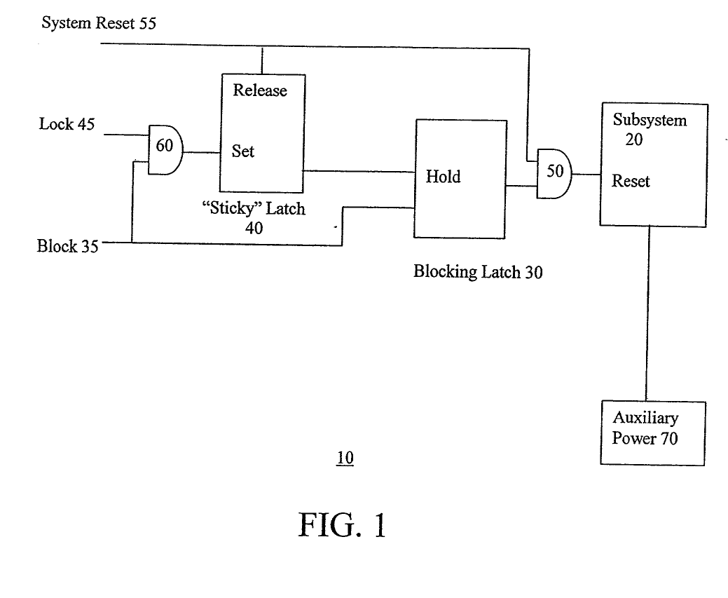

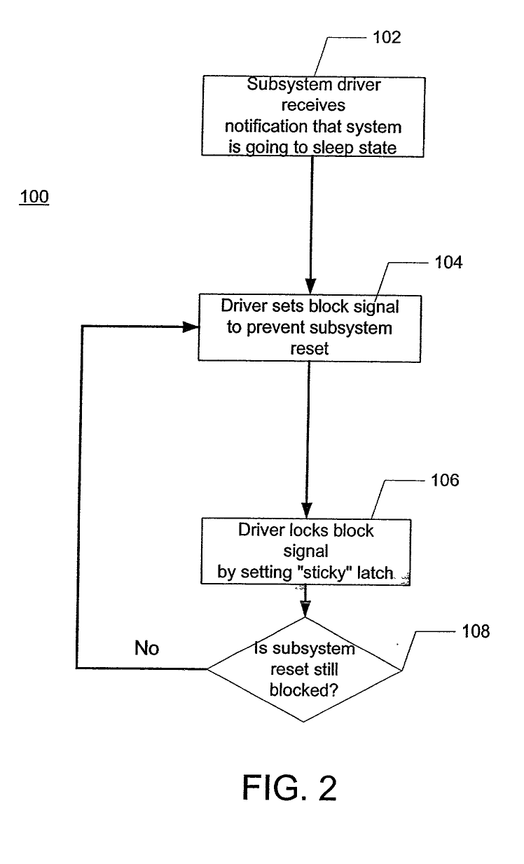

FIG. 1 illustrates a block circuit diagram of a preferred embodiment in accordance with the present invention. As is shown, the cryptographic subsystem 20 is coupled to a blocking latch 30 via a first AND gate 50. The blocking latch 30 is, in turn, coupled to a “sticky” latch 40. Typically, latches 30 and 40, such as those presented in FIG. 2, operate to hold a particular signal, so that elements downstream from the latch do not receive the signal. This type of circuit is well known to those skilled in the art, and will not be discussed in further detail herein.

Referring back to FIG. 1, the “sticky” latch 40 is coupled to a second AND gate 60. The second AND gate 60 receives a Lock input signal 45 and a Block input signal 35. The first AND gate 50 receives a system reset input signal 55 and an input signal from the blocking latch 30. Based on this configuration, the “sticky” latch 40 is set when both the Block input signal 35 and Lock input signal 45 are active. Accordingly, the second AND gate 60 prevents the “sticky” latch 40 from locking the blocking latch 30 before the blocking latch 30 is set and the subsystem reset is blocked. The active block input signal 35 also sets the blocking latch 30. When the system reset signal 55 is active, it releases the “sticky” latch 40, which in turn clears the blocking latch 30, returning direct control to the block input signal 35.

The subsystem 20 and the blocking circuit 10 are powered by an auxiliary power source 70 in the system because the main system power may be shut down during the sleep state. For example in the S3 sleep state, power is typically provided only to the system's memory components and not to other devices. When auxiliary power 70 is initially applied, for example during the initial power up stage, the blocking circuit 10 must reset itself to the non-blocking state in order for the system BIOS to gain access to the subsystem. Under those circumstances, once the system BIOS has had an opportunity to set up the subsystem, the BIOS will protect the subsystem by locking it until the device driver can regain control.

It should be noted that the above described blocking circuit is only one embodiment of a system in which the present invention could be implemented. One of ordinary skill in the art will readily recognize that the present invention can be implemented in various ways while remaining within the spirit and scope of the present invention. For instance, the blocking circuit in FIG. 1 is presented in a positive logic environment, whereby a positive voltage resets the subsystem. In most practical applications, however, circuits are designed to operate in a negative logic environment whereby the absence of a signal would trigger the reset. A person skilled in the art could readily design and implement a circuit operating in a negative logic environment that behaves similarly to the blocking circuit of FIG. 1. Such a design would be within the spirit and scope of the present invention.

FIG. 2 is a flowchart illustrating the powered-off sleep state process 100 in accordance with the present invention. The process starts when the subsystem driver receives notification that the computer system is going into a sleep state, via step 102. Upon such notification, the subsystem driver sets the block signal via a general purpose I/0 (“GPIO”), via step 104, to block a subsystem reset while the system is in the powered off sleep state. Next, in step 106, the subsystem driver locks the block in place using the lock signal (via another GPIO). As a final precaution, the subsystem driver verifies that the subsystem reset is blocked, via step 108. If not, steps 104 and 106 are repeated.

This sets the “sticky” latch and holds the block signal in the blocking latch. According to the embodiment of the present invention, the “sticky” latch may only be set when the block signal is active. By so doing, a rogue application is prevented from interfering with the block signal and compromising security. In this state, the cryptographic subsystem is locked and protected from attack while the system is in the powered-off sleep state. The blocking latch prevents a subsystem reset, and the blocking latch itself is locked by the “sticky” latch. Thus, the subsystem is secure in this state.

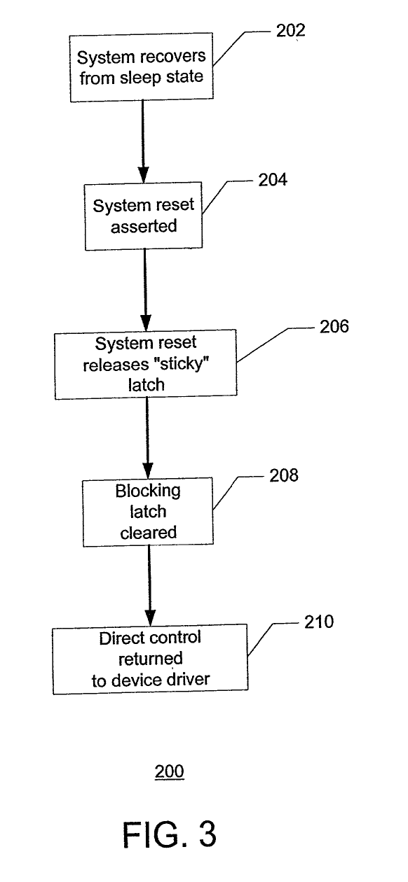

FIG. 3 is a flowchart illustrating the system recovery process 200 in accordance with the present invention. The process 200 begins when the system starts recovering from the sleep state in step 202. A system reset is asserted, via step 204, as part of the recovery process. The system reset, however, is prevented from reaching the subsystem reset due to the state of the blocking latch. De-assertion of the system reset releases the “sticky” latch, via step 206, and thereafter clears the blocking latch in step 208. Direct control of the subsystem is returned to the subsystem driver, via step 210. Because the subsystem reset is blocked when the system reset is asserted, the subsystem remains locked, thereby preventing exposure prior to the subsystem device driver regaining control.

The present invention, therefore, prevents a cryptographic subsystem reset when the computer system is in or recovering from a powered-off sleep state. Accordingly, the subsystem's device driver can regain control of the subsystem before any harm is done to the system by an intruder. Moreover, the present invention affords a portable solution which is simple, cost effective and capable of being easily adapted to current technology. It can be implemented as an add-on feature, such as in an adapter card or the like.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for preventing an unauthorized reset of a subsystem in a processing system, the method comprising the steps of:
a) receiving notification that the processing system is entering a powered off sleep state;
b) setting a first signal for blocking the subsystem reset; and
c) locking the first signal, such that the subsystem is protected from intrusion while entering and recovering from the powered off sleep state.

2. The method of claim 1, wherein a first latch receives the first signal.

3. The method of claim 2, wherein step (c) further includes the step of:
c1) setting a second signal, whereby the second signal sets a second latch and holds the first signal in the first latch.

4. The method of claim 3, whereby the locking step (c) occurs only after the first signal is set.

5. The method of claim 1, wherein at least one device driver sets and locks the first signal after receiving notification that the processing system is entering the powered off sleep state.

6. The method of claim 5, wherein the method further includes the step of:
e) clearing the first signal such that the at least one device driver regains control of the subsystem reset.

7. A method for preventing an unauthorized reset of a cryptographic subsystem in a personal computer system (system), the method comprising the steps of:
a) receiving notification that the system is entering a powered off sleep state;
b) setting a block signal for blocking a cryptographic subsystem reset; and
c) locking the block signal, such that the cryptographic subsystem is protected from intrusion while in and recovering from the powered off sleep state.

8. The method of claim 7, wherein a blocking latch receives the block signal.

9. The method of claim 8, wherein step (c) further includes the step of:
c1) setting a lock signal, whereby the lock signal sets a second latch and holds the block signal in the blocking latch.

10. The method of claim 9, whereby locking step (c) occurs only after the block signal is set.

11. The method of claim 7, wherein at least one device driver sets and locks the block signal after receiving notification that the system is entering the powered off sleep state.

12. The method of claim 11 further comprising the step of:
e) clearing the block signal such that the at least one device driver regains control of the cryptographic subsystem reset.

13. A method for preventing reset of a cryptographic subsystem in a personal computer system when in and recovering from a powered off sleep state, the method comprising the steps of:
a) setting a block signal when a powered off sleep state is being entered for blocking a cryptographic subsystem reset;
b) setting a lock signal for locking the block signal such that the cryptographic subsystem is protected from intrusion while in the powered off sleep state;
c) asserting a system reset when the PC system begins recovering from the powered off sleep state, wherein the system reset releases the lock signal; and
d) clearing the block signal such that the at least one device driver regains control of the cryptographic subsystem reset.

14. The method of claim 13, wherein the block signal prevents the system reset from resetting the cryptographic subsystem.

15. A blocking circuit for preventing a cryptographic subsystem reset when in or recovering from a powered off sleep state, the cryptographic subsystem including at least one device driver, the blocking circuit comprising:
means for setting a block signal when entering the powered off sleep state;
a first latch for receiving the block signal, the first latch being coupled to the cryptographic subsystem reset;
means for setting a lock signal after the block signal has been set; and
a second latch for receiving the lock signal and the block signal, wherein the block signal and the lock signal set the second latch and hold the block signal in the first latch such that the cryptographic subsystem reset is blocked.

16. The blocking circuit of claim 15, wherein at least one device driver sets the block signal.

17. The blocking circuit of claim 16, wherein the at least one device driver sets the lock signal after the block signal has been set.

18. The blocking circuit of claim 17, wherein the means for setting the lock signal and block signal is a general purpose input/output (GPIO).

19. The blocking circuit of claim 17, wherein a system reset following a powered off sleep state releases the second latch, thereby allowing the at least one device driver to regain control of the cryptographic subsystem reset.

20. The blocking circuit of claim 19 further including an auxiliary power source for supplying power to the cryptographic subsystem and the blocking circuit during the powered off sleep state.
